(19) United States
(12) Patent Application Publication
(10) Pub. No.: US 2017/0226008 A1
(43) Pub. Date: Aug. 10, 2017

(54) ALUMINOSILICATE

(71) Applicant: Imerys Minerals Limited, Par, Cornwall (GB)

(72) Inventors: Pierre DANIELLOU, Par, Cornwall (GB); Jean Pierre JOUIN, Par, Cornwall (GB)

(73) Assignee: Imerys Minerals Limited, Par, Cornwall (GB)

(21) Appl. No.: 15/519,174

(22) PCT Filed: Oct. 16, 2015
(86) PCT No.: PCT/EP2015/074058

§ 371 Date: Apr. 14, 2017

(30) Foreign Application Priority Data
Oct. 17, 2014 (EP) 14290314.5

(51) Int. Cl. C04B 14/10; C04B 28/00; C04B 28/02; C04B 20/04

(52) U.S. Cl. CPC C04B 14/106; C04B 20/04; C04B 28/006; C04B 28/02; C04B 2111/00181

(57) ABSTRACT

An aluminosilicate having a pozzolanic activity of greater than about 1400 mg Ca(OH)₂ per gram of aluminosilicate. An aluminosilicate having a pozzolanic activity of less than about 1400 mg Ca(OH)₂ per gram of aluminosilicate and a d₅₀ of 200 μm or less. Binder compositions, clinker compositions and concrete compositions comprising said aluminosilicates. A method of making said aluminosilicates. A clinker composition comprising a first aluminosilicate (e.g. kaolin) and a use of said clinker composition to make a composition comprising said aluminosilicates.

### FIELD OF THE INVENTION

The present invention relates generally to aluminosilicates such as kaolin (e.g. calcined kaolin and metakaolin). In particular, the present invention relates to an aluminosilicate (e.g. metakaolin) having a pozzolanic activity greater than about 1400 mg Ca(OH)₂ per gram of the aluminosilicate and an aluminosilicate (e.g. metakaolin) having a pozzolanic activity of less than about 1400 mg Ca(OH)₂ per gram of the aluminosilicate and a d₅₀ of 200 pm or less. The present invention also relates to compositions (e.g. binder compositions, cementitious compositions, clinker compositions) comprising aluminosilicate, in particular compositions comprising aluminosilicate having a pozzolanic activity greater than about 1400 mg Ca(OH)₂ per gram of the aluminosilicate and compositions comprising aluminosilicate having a pozzolanic activity of less than about 1400 mg Ca(OH)₂ per gram of the aluminosilicate and a d₅₀ of 200 μm or less. The present invention also relates to compositions comprising a first aluminosilicate (e.g. kaolin) such as clinker compositions. The present invention further relates to a method of making an aluminosilicate, in particular an aluminosilicate having a pozzolanic activity greater than about 1400 mg Ca(OH)₂ per gram of the aluminosilicate and an aluminosilicate having a pozzolanic activity of less than about 1400 mg Ca(OH)₂ per gram of the aluminosilicate and a d₅₀ of 200 μm or less.

### BACKGROUND OF THE INVENTION

Pozzolans are materials which have little or no cementitious (e.g. binding) effect itself, but will react with calcium hydroxide in the presence of water to form compounds possessing cementitious properties. Metakaolin, the dehydroxylated form of the clay mineral kaolinite (Al₂Si₂O₅(OH)₄) is a pozzolan having pozzolanic activity. Pozzolans, including metakaolin, may be used for a variety of applications, including in cement and concrete.

Pozzolans, including metakaolin, may be used in cement and concrete to replace some of the Portland cement in a binder (e.g. cement) or concrete composition (for example up to 20% of the Portland cement used in a concrete mix or up to 50% of the clinker in a cement mix). This may reduce the cost of the binder composition and may also reduce the environmental impact of the cement composition, for example because fewer greenhouse gases are emitted during Portland cement production. The inclusion of pozzolans such as metakaolin in cement may also improve the performance characteristics (e.g. durability) of the end product and/or at least not significantly reduce the performance characteristics (e.g. durability) of the end product.

It is thus desirable to provide improved and/or alternative pozzolan(s) such as metakaolin(s), which may be suitable for use in cement and/or concrete. For example, it may be desirable to provide an aluminosilicate such as metakaolin which has increased reactivity (e.g. increased pozzolanic activity), which may, for example, provide improved binder and/or concrete compositions.

### SUMMARY OF THE INVENTION

In accordance with a first aspect of the present invention, there is provided an aluminosilicate such as a metakaolin. The aluminosilicate (e.g. metakaolin) may, for example, be a dry powder. Alternatively, the aluminosilicate (e.g. metakaolin) may be an aqueous suspension.

In accordance with a second aspect of the present invention, there is provided an aluminosilicate (e.g. metakaolin) having a pozzolanic activity of greater than about 1400 mg Ca(OH)₂ per gram of the aluminosilicate (e.g. metakaolin). In accordance with an alternative second aspect of the present invention, there is provided an aluminosilicate (e.g. metakaolin) having a pozzolanic activity of less than about 1400 mg Ca(OH)₂ per gram of aluminosilicate (e.g. metakaolin) and a d₅₀ of 200 μm or less. The aluminosilicate (e.g. metakaolin) may, for example, be a dry powder. Alternatively, the aluminosilicate (e.g. metakaolin) may be an aqueous suspension.

In accordance with a third aspect of the present invention, there is provided a binder composition comprising aluminosilicate (e.g. metakaolin), for example an aluminosilicate (e.g. metakaolin) having a pozzolanic activity of greater than about 1400 mg Ca(OH)₂ per gram of the aluminosilicate (e.g. metakaolin) or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less (e.g. an aluminosilicate according to the first or second aspects of the present invention).

In accordance with a fourth aspect of the present invention, there is provided a cementitious composition comprising aluminosilicate (e.g. metakaolin), for example an aluminosilicate having a pozzolanic activity of greater than about 1400 mg Ca(OH)₂ per gram of the aluminosilicate or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less (e.g. a binder composition according to the third aspect of the present invention).

In accordance with a fifth aspect of the present invention, there is provided a clinker composition comprising an aluminosilicate (e.g. metakaolin), for example an aluminosilicate (e.g. metakaolin) having a pozzolanic activity of greater than about 1400 mg Ca(OH)₂ per gram of the aluminosilicate (e.g. metakaolin) or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less (e.g. an aluminosilicate according to the first or second aspects of the present invention). In certain aspects of the present invention, the aluminosilicate (e.g. kaolin) is not calcined before formation of the clinker composition. Thus, in accordance with a further aspect of the present invention there is provided a clinker composition comprising a first aluminosilicate (e.g. kaolin), wherein the first aluminosilicate (e.g. kaolin) comprises at least about 1% Fe₂O₃ and greater than about 1.5% TiO₂ by weight of the first aluminosilicate (e.g. kaolin). In certain aspects of the present invention, the clinker composition is calcined. Thus, in accordance with a further aspect of the present invention there is provided a use of a clinker composition comprising a first aluminosilicate (e.g. kaolin) to make a composition comprising an aluminosilicate (e.g. metakaolin) (e.g. a composition according to the third or fourth aspects of the present invention), for example wherein the aluminosilicate (e.g. metakaolin) has a pozzolanic activity of greater than about 1400 mg Ca(OH)₂ per gram of the aluminosilicate (e.g. metakaolin) or in the alternative an aluminosilicate (e.g. metakaolin) having pozzolanic activity of less than about 1400 mg Ca(OH)₂ per gram of aluminosilicate (e.g. metakaolin) and a d₅₀ of 200 μm or less (e.g. an aluminosilicate according to the first or second aspects of the present invention).

In accordance with a sixth aspect of the present invention, there is provided a use of an aluminosilicate (e.g. metakaolin), for example an aluminosilicate (e.g. metakaolin) having a pozzolanic activity of greater than about 1400 Ca(OH)₂ per gram of the aluminosilicate (e.g. metakaolin), or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less (e.g. an aluminosilicate according to the first or second aspects of the present invention), in a binder composition and/or in a cementitious composition and/or in a clinker composition.

In accordance with a seventh aspect of the present invention, there is provided a method of making an aluminosilicate (e.g. metakaolin) comprising calcining a first aluminosilicate (e.g. kaolin) to form an aluminosilicate (e.g. metakaolin) (e.g. an aluminosilicate of the first or second aspects of the present invention).

In accordance with an eighth aspect of the present invention, there is provided a method of making an aluminosilicate (e.g. metakaolin) comprising calcining a first aluminosilicate (e.g. kaolin) to form an aluminosilicate (e.g. metakaolin) having a pozzolanic activity of greater than about 1400 mg Ca(OH)₂ per gram of the aluminosilicate (e.g. metakaolin) or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less (e.g. an aluminosilicate according to the second aspect of the present invention).

In accordance with a ninth aspect of the present invention, there is provided an aluminosilicate (e.g. metakaolin) obtained by and/or obtainable by calcining a first aluminosilicate (e.g. kaolin) (e.g. a method according to the seventh or eighth aspects of the present invention).

In accordance with a tenth aspect of the present invention, there is provided an aluminosilicate (e.g. metakaolin) having a pozzolanic activity of greater than about 1400 mg Ca(OH)₂ per gram of the aluminosilicate (e.g. metakaolin), or in the alternative an aluminosilicate (e.g. metakaolin) having a pozzolanic activity of less than about 1400 mg Ca(OH)₂ per gram of aluminosilicate (e.g. metakaolin) and a d₅₀ of 200 μm or less, wherein the aluminosilicate (e.g. metakaolin) is obtained by and/or obtainable by calcining a first aluminosilicate (e.g. kaolin) (e.g. a method according to the seventh or eighth aspects of the present invention).

In certain embodiments of any aspect of the present invention, the aluminosilicate may have a pozzolanic activity greater than about 1400 mg Ca(OH)₂ per gram of the aluminosilicate. In certain embodiments, the aluminosilicate may have a pozzolanic activity equal to or greater than about 1450 mg Ca(OH)₂ per gram of the aluminosilicate. In certain embodiments, the aluminosilicate may have a pozzolanic activity equal to or greater than about 1500 mg Ca(OH)₂ per gram of the aluminosilicate.

In certain embodiments of any aspect of the present invention, the aluminosilicate may have a pozzolanic activity equal to or less than about 1650 mg Ca(OH)₂ per gram of the aluminosilicate. In certain embodiments, the aluminosilicate may have a pozzolanic acitivity equal to or less than about 1600 mg Ca(OH)₂ per gram of the aluminosilicate, for example equal to or less than about 1550 mg Ca(OH)₂ per gram of the aluminosilicate.

In certain embodiments of any aspect of the present invention, the aluminosilicate may have a pozzolanic activity of less than about 1400 mg Ca(OH)₂ per gram of aluminosilicate and a d₅₀ of 200 μm or less. For example, the aluminosilicate may have a pozzolanic activity of less than about 1400 mg Ca(OH)₂ per gram of aluminosilicate and a d₅₀ of 190 μm or less, for example the aluminosilicate may have a pozzolanic activity of less than about 1400 mg Ca(OH)₂ per gram of aluminosilicate and a d₅₀ of 180 μm or less. Alternatively, the aluminosilicate may have a pozzolanic activity of less than about 1350 mg Ca(OH)₂ per gram of aluminosilicate and a d₅₀ of 200 μm or less, for example the aluminosilicate may have a pozzolanic activity of less than about 1300 mg Ca(OH)₂ per gram of aluminosilicate and a d₅₀ of 200 μm or less, for example the aluminosilicate may have a pozzolanic activity of less than about 1200 mg Ca(OH)₂ per gram of aluminosilicate and a d₅₀ of 200 μm or less, for example the aluminosilicate may have a pozzolanic activity of less than about 1100 mg Ca(OH)₂ per gram of aluminosilicate and a d₅₀ of 200 μm or less, for example the aluminosilicate may have a pozzolanic activity of less than about 1000 mg Ca(OH)₂ per gram of aluminosilicate and a d₅₀ of 200 μm or less, for example the aluminosilicate may have a pozzolanic activity of less than about 900 mg Ca(OH)₂ per gram of aluminosilicate and a d₅₀ of 200 μm or less.

In certain embodiments of any aspect of the present invention, the aluminosilicate comprises from about 45% to about 60% SiO₂ by weight of the aluminosilicate. In certain embodiments, the aluminosilicate may comprise from about 51% to about 54% SiO₂ by weight of the aluminosilicate.

In certain embodiments of any aspect of the present invention, the aluminosilicate comprises from about 35% to about 55% Al₂0₃ by weight of the aluminosilicate. In certain embodiments, the aluminosilicate may comprise from about 43% to about 45% Al₂O₃ by weight of the aluminosilicate.

In certain embodiments of any aspect of the present invention, the aluminosilicate comprises from about 0.2% to about 2.0% Fe₂O₃ by weight of the aluminosilicate. In certain embodiments, the aluminosilicate may comprise from about 0.5 to about 1.5% Fe₂O₃ by weight of the aluminosilicate.

In certain embodiments of any aspect of the present invention, the aluminosilicate comprises from about 2.0% to about 3.0% TiO₂ by weight of the aluminosilicate. In certain embodiments, the aluminosilicate may comprise from about 2.3% to about 2.7% TiO₂ by weight of the aluminosilicate. In certain embodiments, the aluminosilicate may comprise from about 2.3% to about 2.5% TiO₂ by weight of the aluminosilicate.

In certain embodiments of any aspect of the present invention, the aluminosilicate may have a d₅₀ of less than about 10 μm. In certain embodiments, the aluminosilicate may have a d₅₀ of less than about 9 μm, In certain embodiments, the aluminosilicate may have a d₅₀ of less than about 8 μm, In certain embodiments, the aluminosilicate may have a d₅₀ of less than about 7 μm. In certain embodiments, the aluminosilicate may have a d₅₀ of less than about 6 μm. In certain embodiments, the aluminosilicate may have a d₅₀ of less than about 5 μm. In certain embodiments, the aluminosilicate may have a d₅₀ of less than about 4 μm. In certain embodiments, the aluminosilicate may have a d₅₀ of about 3 μm.

In certain embodiments of any aspect of the present invention, the aluminosilicate may have a pozzolanic activity of less than about 1400 mg Ca(OH)₂ per gram of aluminosilicate and a d₅₀ of 200 μm or less, for example 190 μm or less, for example 180 μm or less, for example 170 μm or less, for example 160 μm or less. In certain embodiments, the aluminosilicate may have a pozzolanic activity of less than about 1300 mg Ca(OH)₂ per gram of aluminosilicate and a d₅₀ of 200 μm or less, for example 190 μm or less, for example 180 μm or less, for example 170 μm or less, for example 160 μm or less. In certain embodiments, the aluminosilicate may have a pozzolanic activity of less than about 1200 mg Ca(OH)₂ per gram of aluminosilicate and a d₅₀ of 200 μm or less, for example 190 μm or less, for example 180 μm or less, for example 170 μm or less, for example 160 μm or less. In certain embodiments, the aluminosilicate may have a pozzolanic activity of less than about 1100 mg Ca(OH)₂ per gram of aluminosilicate and a d₅₀ of 200 μm or less, for example 190 μm or less, for example 180 pm or less, for example 170 μm or less, for example 160 μm or less. In certain embodiments, the aluminosilicate may have a pozzolanic activity of less than about 1000 mg Ca(OH)₂ per gram of aluminosilicate and a d₅₀ of 200 μm or less, for example 190 μm or less, for example 180 μm or less, for example 170 μm or less, for example 160 μm or less.

In certain embodiments of any aspect of the present invention, the aluminosilicate is derived from a first aluminosilicate (e.g. kaolin) comprising at least about 1% Fe₂O₃ and greater than about 1.5% TiO₂ by weight of the first aluminosilicate (e.g. kaolin).

In certain embodiments of any aspect of the present invention, the aluminosilicate is derived from a first aluminosilicate (e.g. kaolin) comprising at least about 90 wt % kaolinite, for example at least about 92 wt % kaolinite, for example at least about 95 wt % kaolinite, for example at least about 96 wt % kaolinite, for example at least about 97 wt % kaolinite.

In certain embodiments of any aspect of the present invention, the aluminosilicate is used in/present in a binder composition such as cement. In certain embodiments, the binder composition comprises Portland cement. In certain embodiments, the aluminosilicate is used in/present in a clinker composition. In certain embodiments, the aluminosilicate is used in/present in a cementitious composition. In certain embodiments, the aluminosilicate is used in/present in concrete (e.g. speciality concrete). In certain embodiments, the aluminosilicate is used in/present in mortar. In certain embodiments, the aluminosilicate is used in/present in grout. In certain embodiments, the aluminosilicate is used in/present in prefabs. In certain embodiments, the aluminosilicate is used in/present in geopolymers. In certain embodiments, the aluminosilicate is used in/present in 3D printing materials.

The details, examples, embodiments and preferences provided in relation to any particular one or more of the stated aspects of the present invention apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION OF THE INVENTION

The present invention relates to aluminosilicate (e.g. metakaolin) that provides binder compositions and cementitious compositions (e.g. concrete) that have advantageous properties, such as high strength (e.g. high compressive strength). In certain embodiments, the aluminosilicate has a surprisingly high pozzolanic activity. It may therefore be advantageous to use the aluminosilicates described herein in a wide range of applications, including, for example, in cement, clinker, concrete, mortar, grout, prefabs, 3D printing materials and geopolymers. The use of the aluminosilicates described herein may, for example, reduce the amount of Portland cement used in these compositions and may thus reduce the cost and/or environmental impact of these compositions.

Aluminosilicate

There is provided herein an aluminosilicate (e.g. metakaolin). To form the aluminosilicate such as metakaolin, the calcination temperature may be controlled so that the first aluminosilicate (e.g. kaolin) undergoes a characteristic endothermic dehydration reaction, and the original minerals (e.g. kaolinite) may be fully dehydroxylated. The phase that is formed may be known as “metakaolin”. Calcination temperature may be held significantly below that at which the metakaolin collapses as would be indicated by a sharp exotherm in the differential thermal analysis (DTA). In contrast, fully calcined kaolin pigments may be calcined at temperatures above this exotherm.

The aluminosilicate may, for example, be any mineral composed of aluminium, silicon and oxygen. The aluminosilicate may, for example, further comprise counterions. For example, the aluminosilicate may be and/or be derived from kaolin, andalusite, kyanite, sillimanite and other clay minerals. For example, the aluminosilicate may comprise and/or be derived from minerals comprising kaolinite (Al₂Si₂O₅(OH)₄). The aluminosilicate may, for example, be kaolin, fully calcined kaolin, partially calcined kaolin or metakaolin. Hereinafter, the invention may tend to be discussed in terms of metakaolin. However, the invention should not be construed as being limited as such.

The aluminosilicate may, for example, have a pozzolanic activity of greater than about 1400 mg Ca(OH)₂ per gram of aluminosilicate. For example, the aluminosilicate may have a pozzolanic activity equal to or greater than about 1425 mg Ca(OH)₂ per gram of aluminosilicate, for example equal to or greater than about 1450 mg Ca(OH)₂ per gram of aluminosilicate, for example equal to or greater than about 1475 mg Ca(OH)₂ per gram of aluminosilicate. For example, the aluminosilicate may have a pozzolanic activity equal to or greater than about 1500 mg Ca(OH)₂ per gram of aluminosilicate. For example, the aluminosilicate may have a pozzolanic activity equal to about 1500 mg Ca(OH)₂ per gram of the aluminosilicate.

The aluminosilicate may, for example, have a pozzolanic activity equal to or less than about 1650 mg Ca(OH)₂ per gram of aluminosilicate. For example, the aluminosilicate may have a pozzolanic activity equal to or less than about 1600 mg Ca(OH)₂ per gram of aluminosilicate, for example equal to or less than about 1550 mg Ca(OH)₂ per gram of aluminosilicate, for example equal to or less than about 1500 mg Ca(OH)₂ per gram of aluminosilicate, for example equal to or less than about 1450 mg Ca(OH)₂ per gram of aluminosilicate.

The aluminosilicate may, for example, have a pozzolanic activity ranging from greater than about 1400 to about 1650 mg Ca(OH)₂ per gram of aluminosilicate. For example, the aluminosilicate may have a pozzolanic activity ranging from about 1400 to about 1600 mg Ca(OH)₂ per gram of aluminosilicate, for example from about 1425 to about 1550 mg Ca(OH)₂ per gram of aluminosilicate, for example from about 1450 to about 1500 mg Ca(OH)₂ per gram of aluminosilicate.

The pozzolanic activity of the aluminosilicate may, for example, be measured by the modified Chapelle test. Details of the modified Chapelle test can be found in Largent, R. Bull. Liasons Lab. Pont Chauses, Vol. 93, 1978, pp 63, the contents of which are incorporated herein by reference.

The aluminosilicate may, for example, comprise from about 0.2% to about 2.0% Fe₂O₃ by weight of the aluminosilicate. For example, the aluminosilicate may comprise from about 0.3% to about 1.8% Fe₂O₃ by weight of the aluminosilicate, for example from about 0.4% to about 1.6% Fe₂O₃ by weight of the aluminosilicate. For example, the aluminosilicate may comprise from about 0.5% to about 1.5% Fe₂O₃ by weight of the aluminosilicate, for example from about 0.6% to about 1.2% Fe₂O₃ by weight of the aluminosilicate, for example from about 0.7% to about 1.0% Fe₂O₃ by weight of the aluminosilicate.

The aluminosilicate may, for example, comprise from about 2.0% to about 3.0% TiO₂ by weight of the aluminosilicate. For example, the aluminosilicate may comprise from about 2.1% to about 2.9% TiO₂ by weight of the aluminosilicate, for example from about 2.2% to about 2.8% TiO₂ by weight of the aluminosilicate, for example from about 2.3% to about 2.7% TiO₂ by weight of the aluminosilicate. For example, the aluminosilicate may comprise from about 2.0% to about 2.5% TiO₂ by weight of the aluminosilicate. For example, the aluminosilicate may comprise from about 2.4% to about 2.6% TiO₂ by weight of the aluminosilicate. For example, the aluminosilicate may comprise from about 2.1% to about 2.4% TiO₂ by weight of the aluminosilicate.

For example, the aluminosilicate may comprise from about 2.2% to about 2.3% TiO₂by weight of the aluminosilicate.

The aluminosilicate may, for example, comprise from about 35% to about 55% Al₂O₃ by weight of the aluminosilicate. For example, the aluminosilicate may comprise from about 40% to about 50% Al₂0₃ by weight of the aluminosilicate, for example from about 43% to about 45% Al₂O₃ by weight of the aluminosilicate.

The aluminosilicate may, for example, comprise from about 45% to about 60% SiO₂ by weight of the aluminosilicate. For example, the aluminosilicate may comprise from about 50% to about 56% SiO₂ by weight of the aluminosilicate, for example from about 51% to about 54% SiO₂ by weight of the aluminosilicate.

The aluminosilicate may, for example, comprise equal to or greater than about 85% of Al₂O₃ and SiO₂ by weight of the aluminosilicate. For example, the aluminosilicate may comprise equal to or greater than about 90% of Al₂O₃ and SiO₂ by weight of the aluminosilicate, for example equal to or greater than about 95% of Al₂O₃ and SiO₂ by weight of the aluminosilicate, for example equal to or greater than about 96% or 97% or 98% or 99% of Al₂0₃ and SiO₂ by weight of the aluminosilicate.

The aluminosilicate may, for example, comprise equal to or less than about 5% quartz by weight of the aluminosilicate. For example, the aluminosilicate may comprise equal to or less than about 4%, for example equal to or less than about 3%, for example equal to or less than about 2% quartz by weight of the aluminosilicate. For example, the aluminosilicate may comprise equal to or more than about 0%, for example equal to or more than about 0.1% quartz by weight of the aluminosilicate.

The aluminosilicate may, for example, comprise equal to or less than about 1.0% of other minerals by weight of the aluminosilicate. For example, the aluminosilicate may comprise equal to or less than about 0.8% of other minerals, for example equal to or less than about 0.6% of other minerals, for example equal to or less than about 0.5% of other minerals by weight of the aluminosilicate. The other minerals may, for example, be selected from one or more of CaO, MgO, Na₂O, K₂O, SO₃ and P₂O₅. The aluminosilicate may, for example, comprise equal to or less than about 0.20% CaO by weight of the aluminosilicate. The aluminosilicate may, for example comprise equal to or less than about 0.1%,for example equal to or less than about 0.05% MgO by weight of the aluminosilicate. The aluminosilicate may, for example, comprise equal to or less than about 0.05% Na₂O by weight of the aluminosilicate. The aluminosilicate may, for example, comprise equal to or less than about 0.2%, for example equal to or less than about 0.1% K₂O by weight of the aluminosilicate.

It should be understood that the aluminosilicate may comprise these minerals in any amount within the ranges specified herein provided that the total amount of mineral totals 100%. The aluminosilicate may, for example, consist essentially of Al₂O₃, SiO₂, Fe₂O₃ and TiO₂. The aluminosilicate may, for example, consist of Al₂O₃, SiO₂, Fe₂O₃, TiO₂, CaO, MgO, Na₂O and K₂O.

The aluminosilicate may, for example, have a d₅₀ equal to or less than about 10 μm. For example, the aluminosilicate may have a d₅₀ equal to or less than about 9 μm, for example equal to or less than about 8 μm, for example equal to or less than about 7 μm, for example equal to or less than about 6 μm, for example equal to or less than about 5 μm, for example equal to or less than about 4 μm, for example equal to or less than about 3 μm.

For example, the aluminosilicate may have a d₅₀ ranging from about 0.5 μm to about 10 μm. For example, the aluminosilicate may have a d₅₀ ranging from about 1 μm to about 9 μm, for example from about 1 μm to about 8 μm, for example from about 1 μm to about 7 μm, for example from about 1 μm to about 6 μm, for example from about 1 μm to about 5 μm, for example from about 1 μm to about 4 μm. For example, the aluminosilicate may have a d₅₀ ranging from about 2 μm to about 10 μm, for example from about 2 μm to about 9 μm, for example from about 2 μm to about 8 μm, for example from about 2 μm to about 7 μm, for example from about 2 μm to about 6 μm, for example from about 2 μm to about 5 μm, for example from about 2 μm to about 4 μm. The aluminosilicate may, for example, have a d₅₀ of about 3 μm. The aluminosilicate may, for example, have a d₅₀ ranging from about 0.5 μm to about 3 μm, for example from about 1 μm to about 3 μm, for example from about 2 μm to about 3 μm.

The aluminosilicate may, for example, have a d₉₀ equal to or less than about 10 μm. For example, the aluminosilicate may have a d₉₀ equal to or less than about 9 μm, or equal to or less than about 8 μm, or equal to or less than about 7 μm. For example, the aluminosilicate may have a d₉₀ of about 10 μm.

The aluminosilicate may, for example, have a pozzolanic activity of less than about 1400 mg Ca(OH)₂ per gram of the aluminosilicate and a d₅₀ of 200 μm or less. For example, the aluminosilicate may have a pozzolanic activity of less than about 1400 mg Ca(OH)₂ per gram of the aluminosilicate and a d₅₀ or 190 μm or less, for example 180 μm or less, for example 170 μm or less, for example 160 μm or less. For example, the aluminosilicate may have a pozzolanic activity equal to or less than about 1300 mg Ca(OH)₂ per gram of the aluminosilicate and a d₅₀ of 200 μm or less, for example 190 μm or less, for example 180 μm or less, for example 180 μm or less, for example 170 μm or less, for example 160 μm or less. For example, the aluminosilicate may have a pozzolanic activity equal to or less than about 1200 mg Ca(OH)₂ per gram of the aluminosilicate and a d₅₀ of 200 μm or less, for example 190 μm or less, for example 180 μm or less, for example 170 μm or less, for example 160 μm or less. For example, the aluminosilicate may have a pozzolanic activity equal to or less than about 1100 mg Ca(OH)₂ per gram of the aluminosilicate and a d₅₀ of 200 μm or less, for example 190 μm or less, for example 180 μm or less, for example 170 μm or less, for example 160 μm or less. For example, the aluminosilicate may have a pozzolanic acitivity equal to or less than about 1000 mg Ca(OH)₂ per gram of the aluminosilicate and a d₅₀ of 200 μm or less, for example 190 μm or less, for example 180 μm or less, for example 170 μm or less, for example 160 μm or less. For example, the aluminosilicate may have a pozzolanic acitivity equal to or less than about 900 mg Ca(OH)₂ per gram of the aluminosilicate and a d₅₀ of 200 μm or less, for example 190 μm or less, for example 180 μm or less, for example 170 μm or less, for example 160 μm or less.

The aluminosilicate may, for example, have a pozzolanic activity equal to or greater than about 600 mg Ca(OH)₂ per gram of the aluminosilicate and a d₅₀ equal to or greater than about 100 μm. For example, the aluminosilicate may have a pozzolanic activity equal to or greater than about 600 mg Ca(OH)₂ per gram of the aluminosilicate and a d₅₀ equal to or greater than about 110 μm, for example equal to or greater than about 120 μm, for example equal to or greater than about 130 μm, for example equal to or greater than about 140 μm, for example equal to or greater than about 150 μm. For example, the aluminosilicate may have a pozzolanic activity equal to or greater than about 700 mg Ca(OH)₂ per gram of the aluminosilicate and a d₅₀ equal to or greater than about 100 μm, for example equal to or greater than about 110 μm, for example equal to or greater than about 120 μm, for example equal to or greater than about 130 μm, for example equal to or greater than about 140 μm, for example equal to or greater than about 150 μm. For example, the aluminosilicate may have a pozzolanic activity equal to or greater than about 800 mg Ca(OH)₂ per gram of the aluminosilicate and a d₅₀ equal to or greater than about 100 μm, for example equal to or greater than about 110 μm, for example equal to or greater than about 120 μm, for example equal to or greater than about 130 μm, for example equal to or greater than about 140 μm, for example equal to or greater than about 150 μm. For example, the aluminosilicate may have a pozzolanic activity equal to or greater than about 900 mg Ca(OH)₂ per gram of the aluminosilicate and a d₅₀ equal to or greater than about 100 μm, for example equal to or greater than about 110 μm, for example equal to or greater than about 120 μm, for example equal to or greater than about 130 μm, for example equal to or greater than about 140 μm, for example equal to or greater than about 150 μm.

Unless otherwise stated, the particle sizes and other particle size properties referred to herein are measured in a well known manner by sedimentation of the particulate material in a fully dispersed condition in an aqueous medium using a SEDIGRAPH 5100 instrument as supplied by Micrometrics Corporation Norcross, Georgia, USA (telephone: +17706623620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size, or the d₅₀ value, is the value determined in this way of the particle e.s.d. at which there are 50% by weight of the particles which have an equivalent spherical diameter less than that d₅₀ value. The d₉₀ and d₁₀ are the values determined in this way of the particle e.s.d. at which there are 90% and 10% respectively by weight of the particles which have an equivalent spherical diameter less than that d₉₀ or d₁₀ value.

The aluminosilicate may, for example, have a loss on ignition (LOI) equal to or less than about 5%. For example, the aluminosilicate may have a LOI equal to or less than about 4%, for example equal to or less than about 3%, for example equal to or less than about 2%, for example equal to or less than about 1.5%, for example equal to or less than about 1%. The aluminosilicate may, for example have a loss on ignition (LOI) equal to or greater than about 0%, for example equal to or greater than about 0.1%. The loss on ignition (LOI) may, for example, be measured by heating a sample of the aluminosilicate to allow volatile substances (e.g. water, carbon dioxide and hydrates) to escape, until its mass ceases to change. The % weight loss is then determined.

The aluminosilicate may, for example, have a water demand in cement equal to or less than about 1000 g/kg. For example, the aluminosilicate may have a water demand in cement equal to or less than about 950 g/kg, for example equal to or less than about 900 g/kg, for example equal to or less than about 850 g/kg. For example, the aluminosilicate may have a water demand in cement equal to or greater than about 500 g/kg, for example equal to or greater than about 550 g/kg, for example equal to or greater than about 600 g/kg.

The water demand of a cement comprising an aluminosilicate (e.g. metakaolin) having a pozzolanic activity of greater than about 1400 mg Ca(OH)₂ per gram of aluminosilicate (e.g. metakaolin) may, for example, be from about 0% to about 15% greater than the water demand of a cement comprising a corresponding aluminosilicate (e.g. metakaolin) having a pozzolanic activity of less than about 1400 mg Ca(OH)₂ per gram of aluminosilicate (e.g. metakaolin). For example, the water demand of a cement comprising an aluminosilicate (e.g. metakaolin) having a pozzolanic activity of greater than about 1400 mg Ca(OH)₂ per gram of aluminosilicate (e.g. metakaolin) may be from about 0% or about 1% or about 2% to about 12% or about 10% or about 8% or about 6% or about 5% or about 4% or about 3%, for example from about 0% to about 12% or from about 0% to about 8% or from about 1% to about 12% or from about 2% to about 10% or from about 2% to about 8%, greater than the water demand of a cement comprising a corresponding aluminosilicate (e.g. metakaolin) having a pozzolanic activity of less than about 1400 mg Ca(OH)₂ per gram of aluminosilicate.

The water demand in cement may be measured by the method described in NF EN 196-3.

The aluminosilicate may, for example, have a specific surface area (BET) ranging from about 10 m²/g to about 25 m²/g. For example, the aluminosilicate may have a specific surface area (BET) ranging from about 15 m²/g to about 25 m²/g, for example from about 15 m²/g to about 20 m²/g, for example from about 16 m²/g to about 20 m²/g. The specific surface area (BET) may, for example, be measured according to DIN ISO 9277.

There is also provided herein an aluminosilicate (e.g. metakaolin) obtained by and/or obtainable by dehydroxylating a first aluminosilicate (e.g. kaolin), for example by calcining a first aluminosilicate (e.g. kaolin). The aluminosilicate thus obtained may, for example have a pozzolanic activity of greater than about 1400 mg Ca(OH)₂ per gram of aluminosilicate. The aluminosilicate thus obtained may, for example have a pozzolanic activity of less than about 1400 mg Ca(OH)₂ per gram of aluminosilicate and a d₅₀ or 200 μm or less. Alternatively or additionally, the aluminosilicate may, for example, have any one or more of the properties described herein.

The aluminosilicate (e.g. kaolin) from which the metakaolin is prepared (e.g. the first aluminosilicate) may, for example, be sourced from the Para state of Brazil. The aluminosilicate (e.g. kaolin) from which the metakaolin is prepared may, for example, be sourced from the Rio Capim Kaolin deposit.

The aluminosilicate (e.g. metakaolin) may be prepared from a first aluminosilicate (e.g. kaolin) comprising equal to or greater than about 90% kaolinite by weight. For example, the aluminosilicate (e.g. metakaolin) may be prepared from a first aluminosilicate (e.g. kaolin) comprising equal to or greater than about 92%, for example equal to or greater than about 95% kaolinite by weight of the first aluminosilicate (e.g. kaolin). For example, the aluminosilicate (e.g. metakaolin) may be prepared from a first aluminosilicate (e.g. kaolin) comprising equal to or greater than about 96%, for example equal to or greater than about 97% kaolinite by weight of the first aluminosilicate (e.g. kaolin).

The aluminosilicate (e.g. metakaolin) may be prepared from a first aluminosilicate (e.g. kaolin) comprising equal to or greater than about 1.5% TiO₂ by weight of the first aluminosilicate (e.g. kaolin), for example equal to or greater than about 2.0% TiO₂ by weight of the first aluminosilicate (e.g. kaolin), for example equal to or greater than about 2.5% TiO₂ by weight of the first aluminosilicate (e.g. kaolin).

The aluminosilicate (e.g. metakaolin) may be prepared from a first aluminosilicate (e.g. kaolin) comprising equal to or greater than about 1.0% Fe₂O₃ by weight of the first aluminosilicate (e.g. kaolin), for example equal to or greater than about 1.2% Fe₂O₃ by weight of the first aluminosilicate (e.g. kaolin), for example equal to or greater than about 1.5% Fe₂O₃ by weight of the first aluminosilicate (e.g. kaolin).

The aluminosilicate (e.g. metakaolin) may be prepared from a first aluminosilicate (e.g. kaolin) having a d₅₀ of less than about 50 μm. For example, the first aluminosilicate (e.g. kaolin) may have a d₅₀ of less than about 45 μm, for example less than about 43 μm, for example less than about 40 μm.

The aluminosilicate (e.g. metakaolin) may be prepared from a first aluminosilicate (e.g.

kaolin) that is milled prior to calcination to form the aluminosilicate (e.g. metakaolin). The first aluminosilicate (e.g. kaolin) may, for example, be milled such that it has a d₈₀ of 10 μm or less, for example 9 μm or less, for example 8 μm or less, for example 7 μm or less prior to calcination to form the aluminosilicate (e.g. metakaolin).

The aluminosilicate (e.g. metakaolin) may be prepared from a feed having an elementary particle size of less than about 2 μm, for example less than about 1.5 μm, for example less than about 1 μm, for example less than about 0.5 μm, for example less than about 0.4 μm, for example less than about 0.3 μm, for example about 0.2 μm.

There is also provided compositions comprising or consisting essentially of the aluminosilicates described herein. For example, the composition may have any one or more of the properties of the aluminosilicates described herein. For example, the composition may have a pozzolanic activity greater than about 1400 mg Ca(OH)₂ per gram of aluminosilicate. For example, the composition may have a pozzolanic activity less than 1400 mg Ca(OH)₂ per gram of aluminosilicate and a d₅₀ of 200 μm or less.

Uses of the Aluminosilicate

The aluminosilicates (e.g. metakaolins) described herein may, for example, be used as a pozzolan. For example, the aluminosilicates (e.g. metakaolins) described herein may be used either alone or in combination with one or more mineral(s) to provide pozzolanic activity. For example, the aluminosilicate (e.g. metakaolins) described herein may be used in combination with one or more mineral(s) selected from the group comprising alkaline earth metal carbonate (for example limestone, dolomite, i.e. CaMg(CO₃)₂), metal sulphate (for example gypsum), metal silicate, metal oxide (for example iron oxide, chromia, antimony trioxide or silica), metal hydroxide, wollastonite, bauxite, talc (for example, French chalk), mica, zinc oxide (for example, zinc white or Chinese white), titanium dioxide (for example, anatase or rutile), silicon dioxide, zinc sulphide, calcium carbonate (for example precipitated calcium carbonate (PCC), ground calcium carbonate (GCC) or surface-modified calcium carbonate), barium sulphate (for example, barite, blanc fixe or process white), alumina hydrate (for example, alumina trihydrate, light alumina hydrate, lake white or transparent white), phyllosilicate minerals (including kaolinite, halloysite, illite, montmorillonite, bentonite, wollastonite, talc, chlorite and mica), clay (e.g. hydrous or partially calcined or fully calcined, for example kaolin, calcined kaolin, China clay or bentonite), slag, rhyolite, sand and combinations thereof. The one or more mineral(s) may, for example, be calcined before combination with the alumniosilicate. For example, the aluminosilicates (e.g. metakaolins) described herein may be used in combination with (e.g. in a blend with) calcium carbonate to provide pozzolanic activity. When the aluminosilicates (e.g. metakaolins) described herein are used in combination with one or more mineral(s) such as calcium carbonate, the majority of the inorganic particulate material present may be the aluminosilicate (e.g. metakaolin) described herein. The total inorganic particulate material present may, for example, act as a pozzolan due to the high pozzolanic activity of the aluminosilicate (e.g. metakaolin) described herein.

The aluminosilicates (e.g. metakaolins) or mineral mixtures comprising the aluminosilicate described herein may, for example, be used in any one or more of cement (e.g. Portland cement, blended cement, geopolymer cement), concrete (e.g. speciality concretes such as high performance concrete, high strength concrete, lightweight concrete, self-compacting concrete, prefabricated or precast concrete), mortar, grout, in 3D printing materials (e.g. in combination with gypsum based materials) and as or in geopolymers. In particular, the aluminosilicates (e.g. metakaolins) described herein may be used in binder compositions (e.g. cement) and cementitious compositions (e.g. concrete and mortar). The also disclosed herein are binder compositions (e.g. cement) or cementitious compositions (e.g. concrete) or mortar or grout or 3D printing materials or geopolymers comprising the aluminosilicates (e.g. metakaolins) described herein.

There is provided herein a use of an aluminosilicate (e.g. metakaolin) in a composition such as a binder composition and/or a clinker composition and/or a cementitious composition. There is also provided herein a composition such as a binder composition and/or a clinker composition and/or a cementitious composition comprising an aluminosilicate (e.g. metakaolin). There is further provided herein a method for making a composition such as a binder composition and/or a clinker composition and/or a cementitious composition comprising combining aluminosilicate with the other components of these compositions. The aluminosilicate (e.g. metakaolin) may, for example, have a pozzolanic activity of greater than about 1400 mg Ca(OH)₂ per gram of aluminosilicate (e.g. metakaolin). The aluminosilicate (e.g. metakaolin) may, for example, have a pozzolanic activity of less than about 1400 mg Ca(OH)₂ per gram of aluminosilicate (e.g. metakaolin) and a d₅₀ of 200 μm or less. Alternatively or additionally, the aluminosilicate (e.g. metakaolin) may, for example, have any one or more of the properties described herein. When making a binder composition or cementitious composition or clinker composition according to the present invention, the components of these compositions may suitably be added to the composition in any order and/or combination. For example, Portland cement and an aluminosilicate (e.g.

metakaolin) may be combined to form a binder composition and this binder composition may be added to a granular material to make a concrete composition. Alternatively, Portland cement and aluminosilicate (e.g. metakaolin) may be added separately to a granular material (in any order) to make a concrete composition. The aluminosilicates described herein may, for example, be used in binder compositions (e.g. cement) to replace up to about 50 wt % of clinker, for example up to about 40 wt % or up to about 30 wt % of clinker.

The binder composition may, for example, be cement (e.g. Portland cement or blended cement or geopolymer cement). The binder composition may, for example, comprise Portland cement and metakaolin. Portland cement is a fine powder produced by grinding Portland cement clinker, calcium sulphate and up to about 5 wt % minor constituents according to the appropriate standards. Portland cement clinker is a hydraulic material which typically consists of at least two thirds by mass of calcium silicates, the remainder comprising aluminium and iron containing clinker phases and other compounds. The ratio of CaO to SiO₂ may typically not be less than 2 and the MgO content may not exceed 5% by mass. Typical constituents in mass percent of Portland clinker are tricalcium silicate (45-75%), dicalcium silicate (7-32%), tricalcium aluminate (0-13%), tetracalcium aluminoferrite (0-18%), gypsum, i.e. calcium sulphate (2-10%) and in Portland cement are calcium oxide (61-67%), silicon oxide (19-23%), aluminium oxide (2.5-6%), ferric oxide (0-6%). The Portland cement clinker may, for example, be a clinker composition as described herein.

The Portland cement may, for example, be ordinary Portland cement (OPC). The Portland cement may, for example, be white Portland cement. For example, the Portland cement may be ASTM C150 Portland cement (e.g. any one or more of types I, II, III, IV, V, Ia, IIa, IIIa, II(MH) and II(MH)a). For example, the Portland cement may be EN 197 (e.g. any one or more of classes I, II, III, IV and V). The Portland cement may, for example, include those components that satisfy British Standard BS12 (EN 197-1:2000).

The binder compositions described herein may, for example, be used to form a range of cementitious compositions. For example, the binder compositions disclosed herein may be used to form concrete (e.g. speciality concretes, prefab or precast concrete or self-compacting concrete), mortar and/or grout. The aluminosilicates described herein may, for example, be used in cementitious compositions (e.g. concrete) to replace up to about 20 wt % of the binder compositions (e.g. cement), for example up to about 15 wt % or up to about 10 wt % of the binder compositions (e.g. cement).

The binder composition (e.g. cement) may, for example, have a water demand equal to or less than about 1000 g/kg. For example, the binder composition (e.g. cement) may have a water demand equal to or less than about 950 g/kg, for example equal to or less than about 900 g/kg, for example equal to or less than about 850 g/kg. For example, the binder composition (e.g. cement) may have a water demand equal to or greater than about 500 g/kg, for example equal to or greater than about 550 g/kg, for example equal to or greater than about 600 g/kg.

The water demand of the binder composition (e.g. cement) may, for example, be from about 0% to about 15% greater than the water demand of a binder composition (e.g. cement) comprising a corresponding aluminosilicate (e.g. metakaolin) having a pozzolanic activity of less than about 1400 mg Ca(OH)₂ per gram of aluminosilicate (e.g. metakaolin). For example, the water demand of the binder composition (e.g.

cement) may be from about 0% or about 1% or about 2% to about 12% or about 10% or about 8% or about 6% or about 5% or about 4% or about 3%, for example from about 0% to about 12% or from about 0% to about 8% or from about 1% to about 12% or from about 2% to about 10% or from about 2% to about 8%, greater than the water demand of a corresponding binder composition (e.g. cement) comprising a corresponding aluminosilicate (e.g. metakaolin) having a pozzolanic activity of less than about 1400 mg Ca(OH)₂ per gram of aluminosilicate.

Concrete is a composite material comprising granular material embedded in a hard matrix of material (e.g. a binder composition such as cement). Concrete may, for example, comprise any one or more of gravel, crushed stone, sand, cement binder, water, chemical additives, mineral additives, and other additives, such as, for example, fibers. The composite is formed by combining the components in accordance with established practice and standards, depending on the type of concrete required and its intended use. Aggregates can be up to 20 mm in size, for example, about 10 mm in size. Examples of chemical additives are superplasticisers, air entrainers, retarders, accelerators, pigments and corrosion inhibitors. Examples of mineral additives include, in addition to the pozzolanic materials described herein, fly ash and silica fume.

The concrete compositions may, for example, be selected from one or more of high performance concrete, high strength concrete, lightweight concrete, precast and poured-mold concrete, slab concrete, self-compacting concrete, glass fiber reinforced concrete and special concretes for hostile environment.

Mortar and grout are composite materials comprising primarily cement binder, sand and water, and sometimes fine gravel.

There is provided herein clinker compositions comprising aluminosilicate (e.g. metakaolin) as described herein and clinker compositions comprising a first aluminosilicate (e.g. kaolin), wherein the first aluminosilicate (e.g. kaolin) comprises at least about 1% Fe₂O₃ and greater than about 1.5% TiO₂ by weight of the first aluminosilicate (e.g. kaolin). The clinker compositions generally comprise lumps or nodules of material, generally produced by sintering limestone and alumina-silicate materials (e.g. metakaolin as described herein and/or kaolin comprising at least about 1% Fe₂O₃ and greater than about 1.5% TiO₂ by weight of the kaolin). The lumps or nodules are typically from 3 mm to 25 mm in diameter. The first aluminosilicate (e.g. kaolin) may, for example, comprise equal to or greater than about 90% by weight kaolinite, for example equal to or greater than about 95% by weight kaolinite.

The clinker composition may, for example, be made by combining an aluminosilicate (e.g. metakaolin) as described herein (for example an aluminosilicate (e.g. metakaolin) having a pozzolanic activity of greater than about 1400 mg Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less) with limestone and sintering the composition comprising limestone and aluminosilicate (e.g. metakaolin) to form a clinker composition. Alternatively, the clinker composition may be made by combining a first aluminosilicate (e.g. kaolin), for example a first aluminosilicate (e.g. kaolin) comprising at least about 1% Fe₂O₃ and greater than about 1.5% TiO₂ by weight of the first aluminosilicate (e.g. kaolin), with limestone and calcining the composition comprising limestone and kaolin to form a composition comprising limestone (e.g. calcined limestone) and aluminosilicate (e.g. metakaolin) (e.g. an aluminosilicate (e.g. metakaolin) having a pozzolanic activity of greater than about 1400 Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less). The first aluminosilicate (e.g. kaolin) may, for example, comprise equal to or greater than about 90% by weight kaolinite, for example equal to or greater than about 95% by weight kaolinite. The composition comprising limestone (e.g. calcined limestone) and aluminosilicate (e.g. metakaolin) (e.g. an aluminosilicate (e.g. metakaolin) having a pozzolanic activity of greater than about 1400 Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less) may then be sintered to form a clinker composition. Thus, in accordance with some aspects of the present invention, there is provided a composition comprising limestone (e.g. calcined limestone) and aluminosilicate (e.g. metakaolin) (e.g. an aluminosilicate (e.g. metakaolin) having a pozzolanic activity of greater than about 1400 mg Ca(OH)₂ per gram of aluminosilicate (e.g. metakaolin)). In accordance with some aspects of the present invention, there is provided a composition comprising limestone (e.g. calcined limestone) and aluminosilicate (e.g. metakaolin) (e.g. an aluminosilicate (e.g. metakaolin) having a pozzolanic activity of less than about 1400 mg Ca(OH)₂ per gram of aluminosilicate (e.g. metakaolin) and a d₅₀ of 200 μm or less).

The clinker composition comprising aluminosilicate (e.g. metakaolin) may, for example, be ground to form a composition comprising aluminosilicate (e.g. metakaolin). This composition may, for example, be used as a binder. This composition may, for example, be used in a cementitious composition described herein.

In some embodiments, the first aluminosilicate (e.g. kaolin) is not calcined before the formation of the clinker composition and there is thus provided herein a clinker composition comprising limestone and a first aluminosilicate (e.g. kaolin), for example a first aluminosilicate (e.g. kaolin) comprising at least about 1% Fe₂O₃ and greater than about 1.5% TiO₂ by weight of the first aluminosilicate (e.g. kaolin). The first aluminosilicate (e.g. kaolin) may, for example, comprise equal to or greater than about 90% by weight kaolinite, for example equal to or greater than about 95% by weight kaolinite. This clinker composition may, for example, be used to prepare compositions comprising aluminosilicate (e.g. metakaolin). For example, the clinker composition may be calcined to make a clinker composition comprising aluminosilicate (e.g. metakaolin), for example to make a clinker composition comprising aluminosilicate (e.g. metakaolin) having a pozzolanic activity greater than about 1400 mg Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less. The clinker composition comprising a first aluminosilicate (e.g. kaolin) may, for example, be ground and the ground composition may, for example, be calcined to make a composition comprising aluminosilicate (e.g. metakaolin), for example a composition comprising aluminosilicate (e.g. metakaolin) having a pozzolanic activity of greater than about 1400 mg Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less. This composition may, for example, be used as a binder. This composition may, for example be used in a cementitious composition described herein.

The first aluminosilicate (e.g. kaolin) used to make the clinker compositions described herein may, for example, comprise equal to or greater than about 1.5% TiO₂ by weight of the first aluminosilicate (e.g. kaolin), for example equal to or greater than about 2.0% TiO₂ by weight of the first aluminosilicate (e.g. kaolin), for example equal to or greater than about 2.5% TiO₂ by weight of the first aluminosilicate (e.g. kaolin). The kaolin may, for example, comprise equal to or greater than about 1.0% Fe₂O₃ by weight of the first aluminosilicate (e.g. kaolin), for example equal to or greater than about 1.2% Fe₂O₃ by weight of the first aluminosilicate (e.g. kaolin), for example equal to or greater than about 1.5% Fe₂O₃ by weight of the first aluminosilicate (e.g. kaolin). The first aluminosilicate (e.g. kaolin) may, for example, comprise equal to or greater than about 90% kaolinite by weight of the first aluminosilicate (e.g. kaolin), for example equal to or greater than about 95%, for example equal to or greater than about 96%, for example equal to or greater than about 97% kaolinite by weight of the first aluminosilicate (e.g. kaolin). The first aluminosilicate (e.g. kaolin) may, for example, be obtained from the

Para state of Brazil. For example, the first aluminosilicate (e.g. kaolin) may be obtained from the Rio Capim deposit.

The first aluminosilicate (e.g. kaolin) may have a d₅₀ of less than about 50 μm. For example, the first aluminosilicate (e.g. kaolin) may have a d₅₀ of less than about 45 μm, for example less than about 43 μm, for example less than about 40 μm.

Method of Making Metakaolin

There is provided herein a method of making an aluminosilicate (e.g. metakaolin) comprising dehydroxylating (e.g. calcining) a first aluminosilicate (e.g. kaolin). The aluminosilicate (e.g. metakaolin) may have a pozzolanic activity greater than about 1400 mg Ca(OH)₂ per gram of aluminosilicate (e.g. metakaolin). The aluminosilicate (e.g. metakaolin) may have a pozzolanic acitivity of less than about 1400 mg Ca(OH)₂ per gram of aluminosilicate (e.g. metakaolin) and a d₅₀ of 200 μm or less. Alternatively or additionally, the aluminosilicate (e.g. metakaolin) may have any one or more of the properties described herein. Thus, there is also provided herein an aluminosilicate (e.g.

metakaolin) (e.g. an aluminosilicate (e.g. metakaolin) having a pozzolanic activity greater than about 1400 mg Ca(OH)₂ per gram of aluminosilicate (e.g. metakaolin) or an aluminosilicate (e.g. metakaolin) having a pozzolanic activity of less than about 1400 mg Ca(OH)₂ per gram of aluminosilicate (e.g. metakaolin) and a d₅₀ of 200 μm or less) obtained by and/or obtainable by dehydroxylating (e.g. calcining) a first aluminosilicate (e.g. kaolin).

The first aluminosilicate (e.g. kaolin) from which the aluminosilicate (e.g. metakaolin) is prepared may, for example, be as described above in the section relating to the aluminosilicate (e.g. metakaolin) per se.

The first aluminosilicate (e.g. kaolin) from which the aluminosilicate is prepared may, for example, undergo one or more sizing and/or comminution steps prior to dehydroxylation to form aluminosilicate. For example, the first aluminosilicate (e.g. kaolin) may undergo comminution by crushing or grinding or milling. For example, the first aluminosilicate (e.g. kaolin) may undergo sizing using screens, centrifuges, cyclones and air classifiers. Screening can be performed using screens of a desired mesh, such as a 325 mesh screen. Other methods include gravity sedimentation or elutriation, any type of hydrocyclone apparatus, or, for example, a solid bowl decanter centrifuge, and disc nozzle centrifuge. The resultant coarse fraction may be discarded, used as a separate product or, for example, may be redirected back to the comminution tank.

The first aluminosilicate (e.g. kaolin) from which the aluminosilicate (e.g. metakaolin) is prepared may have a d₅₀ of about 50 μm or less, for example about 45 μm or less, for example about 40 μm or less.

The first aluminosilicate (e.g. kaolin) from which the aluminosilicate (e.g. metakaolin) is prepared may be milled prior to calcination (e.g. flash calcination) to form the aluminosilicate (e.g. metakaolin). The first aluminosilicate (e.g. kaolin) may, for example, be milled such that it has a d₈₀ of 10 μm or less, for example 9 μm or less, for example 8 μm or less, for example 7 μm or less prior to calcination (e.g. flash calcination).

The feed material for preparing the aluminosilicate (e.g. metakaolin) may have an elementary particle size of less than about 2 μm, for example less than about 1.5 μm, for example less than about 1 μm, for example less than about 0.5 μm, for example less than about 0.4 μm, for example less than about 0.3 μm, for example about 0.2 μm.

The first aluminosilicate (e.g. kaolin) may, for example, undergo dehydroxylation by calcination. This is a thermal treatment process, generally in the presence of air or oxygen. Calcination changes the kaolin structure from crystalline to amorphous. The degree to which hydrous aluminosilicate (e.g. kaolin) undergoes changes in crystalline form may depend on the amount of heat to which it is subjected. Generally, the higher the temperature, the shorter the calcination time. Generally, calcination is performed at temperatures ranging from about 550° C. to about 950° C. (for example from about 750° C. to about 950° C., for example from about 850° C. to about 900° C.) to produce the aluminosilicate (e.g. metakaolin). Further heating to temperatures around about 900 to 950° C. may result in further structural changes such as densification and formation of an aluminium-silicon spinel (Si₃Al₄O₁₂). At approximately 950° C., amorphous regions of aluminosilicate (e.g. metakaolin) may begin to re-crystallize. Further heating to temperatures around about 1050° C. and above may result in further structural changes to form mullite 3Al₂O₃.2SiO₂ and highly crystalline cristobalite SiO₂.

For example, any furnace, kiln or other suitable heating apparatus may be used for the calcination of the first aluminosilicate (e.g. kaolin). A typical procedure involves heating aluminosilicate (e.g. kaolin) in a kiln, for example a conventional rotary kiln. Typically, the aluminosilicate (e.g. kaolin) may be introduced into the kiln as an extrudate from a pug mill. As the first aluminosilicate (e.g. kaolin) proceeds through the kiln, typically at a starting moisture content of about 25% by weight to facilitate the extrusion of the first aluminosilicate (e.g. kaolin), the extrudate breaks down into pellets as a result of the calcination process. A small amount of binder (such as alum) may be added to the first aluminosilicate (e.g. kaolin) to provide “green strength” to the first aluminosilicate (e.g. kaolin) so as to prevent the kaolin from completely breaking down into powder form during the calcination process.

The calcination process used may, for example, be soak calcining, i.e. wherein the hydrous aluminosilicate (e.g. kaolin) or clay is calcined for a period of time during which the chemistry of the material is gradually changed by the effect of heating. The calcining may for example be for a period of at least 1 minute, in many cases at least 10 minutes, e.g. from 30 minutes to five or more hours. Known devices suitable for carrying out soak calcining include high temperature ovens, rotary kilns and vertical kilns.

The calcination process may, for example, be flash calcining, wherein the hydrous first aluminosilicate (e.g. kaolin) is typically rapidly heated over a period of less than one second, e.g. less than 0.5 second. Flash calcination may, for example, introduce aluminosilicate (e.g. kaolin) (e.g. water washed kaolin) to a hot gas stream for a few seconds. Flash calcination refers to heating a material at an extremely fast rate, almost instantaneously. The heating rate in a flash calciner may be of the order of 56,000° C. per second or greater, such as about 100,000° C. to about 200,000° C. per second. The aluminosilicate (e.g. metakaolin) may, for example, be prepared by flash calcination, wherein the clay may be exposed to a temperature greater than 500° C. for a time not more than 5 seconds. The aluminosilicate (e.g. clay) may, for example, be calcined to a temperature in the range of from 550° C. to 1200° C.; for microsecond periods the temperature may be as high as 1500° C. The aluminosilicate (e.g. clay) may be calcined to a temperature in the range of from 800° C. to 1100° C.; for example a temperature in the range of from 900° C. to 1050° C.; for example a temperature in the range of from 950° C. to 1000° C. The aluminosilicate (e.g. clay) may, for example, be calcined for a time less than 5 seconds; for example for less than 1 second; for example for less than 0.5 seconds; for example for less than 0.1 second. Flash calcination of aluminosilicate (e.g. kaolin) particles gives rise to relatively rapid blistering of the particles caused by relatively rapid dehydroxylation of the aluminosilicate (e.g. kaolin). Water vapour is generated during calcination which may expand extremely rapidly, in fact generally faster than the water vapour can diffuse through the crystal structure of the particles. The pressures generated are sufficient to produce sealed voids as the interlayer hydroxyl groups are driven off, and it is the swollen interlayer spaces, voids, or blisters between the kaolin platelets which typify flash calcined aluminosilicates (e.g. kaolins) and give them characteristic properties.

The flash calcination process may, for example, be carried out by injecting the aluminosilicate (e.g. kaolin clay) into a combustion chamber or furnace wherein a vortex may be established to rapidly remove the calcined aluminosilicate (e.g. clay) from the combustion chamber. A suitable furnace would be one in which a toroidal fluid flow heating zone is established such as the device described in WO 99/24360 and corresponding applications U.S. Pat. No. 6,334,894 and U.S. Pat. No. 6,136,740, the contents of which are herein incorporated by reference in their entirety.

The aluminosilicate (e.g. metakaolin) thus formed may, for example, undergo one or more sizing and/or comminution steps, for example prior to being incorporated into a binder composition or cementitious composition. For example, the aluminosilicate (e.g.

metakaolin) may undergo comminution by crushing or grinding or milling as will be known to those skilled in the art. For example, the aluminosilicate (e.g. metakaolin) may undergo sizing using screens, centrifuges, cyclones and air classifiers. The aluminosilicate (e.g. metakaolin) may, for example, undergo densification or concentration steps, for example by gravity concentration, froth flotation and/or dewatering.

The aluminosilicate (e.g. metakaolin) may, for example, be combined with one or more filler(s). The one or more filler(s) may, for example, be selected from limestone, clay (e.g. hydrous or partially calcined or fully calcined), slag, rhyolite, sand and combinations thereof. For example, the one or more filler(s) may be selected from calcium carbonate (including ground calcium carbonate (GCC) and precipitated calcium carbonate (PCC)), phyllosilicate minerals (including kaolinite, halloysite, illite, montmorillonite, talc, chlorite and mica) and silicon dioxide. The one or more filler(s) may, for example, be calcined before combination with the aluminosilicate (e.g. metakaolin).

The foregoing broadly describes certain embodiments of the present invention without limitation. Variations and modifications as will be readily apparent to those skilled in the art are intended to be within the scope of the present invention as defined in and by the appended claims.

### EXAMPLES

Hard kaolin obtained from the Rio Capim deposit in Brazil was calcined at temperatures ranging from 590° C. to 840° C. to produce a metakaolin. This metakaolin was found to have a loss on ignition (LOI) of <2%.

This metakaolin was tested for pozzolanic activity using the modified Chapelle test described previously. It was surprisingly found that this metakaolin had a pozzolanic activity between 1450 and 1650 mg Ca(OH)₂ per gram of metakaolin.

The following numbered paragraphs define particular embodiments of the present invention:

1. An aluminosilicate having a pozzolanic activity of greater than about 1400 mg Ca(OH)₂ per gram of aluminosilicate.

2. The aluminosilicate according to paragraph 1, wherein the aluminosilicate has a pozzolanic activity equal to or greater than about 1450 mg Ca(OH)₂ per gram of aluminosilicate, for example equal to or greater than about 1500 mg Ca(OH)₂ per gram of aluminosilicate.

3. The aluminosilicate according to paragraph 1 or paragraph 2, wherein the aluminosilicate has a pozzolanic activity equal to or less than about 1650 mg Ca(OH)₂ per gram of aluminosilicate, for example equal to or less than about 1600 mg Ca(OH)₂ per gram of aluminosilicate, for example equal to or less than about 1500 mg Ca(OH)₂ per gram of aluminosilicate.

4. The aluminosilicate according to any one of paragraphs 1 to 3, wherein the aluminosilicate comprises from about 45% to about 60% SiO₂ by weight of the aluminosilicate, for example from about 51% to about 54% SiO₂ by weight of the aluminosilicate.

5. The aluminosilicate according to any one of paragraphs 1 to 4, wherein the aluminosilicate comprises from about 35% to about 55% Al₂O₃ by weight of the aluminosilicate, for example from about 43% to about 45% Al₂O₃ by weight of the aluminosilicate.

6. The aluminosilicate according to any one of paragraphs 1 to 5, wherein the aluminosilicate comprises from about 0.2% to about 2.0% Fe₂O₃ by weight of the aluminosilicate, for example from about 0.5% to about 1.5% Fe₂O₃ by weight of the aluminosilicate.

7. The aluminosilicate according to any one of paragraphs 1 to 6, wherein the aluminosilicate comprises from about 2.0% to about 3.0% TiO₂ by weight of the aluminosilicate, for example from about 2.3% to about 2.5% TiO₂ by weight of the aluminosilicate.

8. The aluminosilicate according to any one of paragraphs 1 to 7, wherein the aluminosilicate has a d₅₀ of less than about 10 μm, for example less than about 9 μm, for example less than about 8 μm, for example less than about 7 μm, for example less than about 6 μm, for example less than about 5 μm, for example less than about 4 μm, for example about 3 μm.

9. The aluminosilicate according to any one of paragraphs 1 to 8, wherein the aluminosilicate is derived from a first aluminosilicate (e.g. kaolin) comprising at least about 1% Fe₂O₃ and greater than about 1.5% TiO₂ by weight of the first aluminosilicate (e.g. kaolin).

10. The aluminosilicate according to any one of paragraphs 1 to 9, wherein the aluminosilicate is derived from a first aluminosilicate (e.g. kaolin) comprising equal to or greater than about 90% kaolinite by weight of the first aluminosilicate (e.g. kaolin), for example equal to or greater than about 95% kaolinite by weight of the first aluminosilicate (e.g. kaolin).

11. The aluminosilicate according to any one of paragraphs 1 to 10, wherein the aluminosilicate has a water demand in cement equal to or less than about 1000 g/kg, for example equal to or less than about 950 g/kg, for example equal to or less than about 900 g/kg.

12. The aluminosilicate according to any one of paragraphs 1 to 11, wherein the aluminosilicate is derived from kaolin.

13. The aluminosilicate according to any one of paragraphs 1 to 12, wherein the aluminosilicate is metakaolin.

14. An aluminosilicate having a pozzolanic activity of less than about 1400 mg Ca(OH)₂ per gram of aluminosilicate and a d₅₀ of about 200 μm or less.

15. The aluminosilicate according to paragraph 14, wherein the aluminosilicate has a pozzolanic activity less than about 1300 mg Ca(OH)₂ per gram of aluminosilicate, for example less than about 1200 mg Ca(OH)₂ per gram of aluminosilicate, for example less than about 1100 mg Ca(OH)₂ per gram of aluminosilicate. for example less than about 1000 mg Ca(OH)₂ per gram of aluminosilicate, for example less than about 900 mg Ca(OH)₂ per gram of aluminosilicate, for example about 800 mg Ca(OH)₂ per gram of aluminosilicate.

16. The aluminosilicate according to any one of paragraphs 14 to 15, wherein the aluminosilicate comprises from about 45% to about 60% SiO₂ by weight of the aluminosilicate, for example from about 51% to about 54% SiO₂ by weight of the aluminosilicate.

17. The aluminosilicate according to any one of paragraphs 14 to 16, wherein the aluminosilicate comprises from about 35% to about 55% Al₂O₃ by weight of the aluminosilicate, for example from about 43% to about 45% Al₂O₃ by weight of the aluminosilicate.

18. The aluminosilicate according to any one of paragraphs 14 to 17, wherein the aluminosilicate comprises from about 0.2% to about 2.0% Fe₂O₃ by weight of the aluminosilicate, for example from about 0.5% to about 1.5% Fe₂O₃ by weight of the aluminosilicate.

19. The aluminosilicate according to any one of paragraphs 14 to 18, wherein the aluminosilicate comprises from about 2.0% to about 3.0% TiO₂ by weight of the aluminosilicate, for example from about 2.3% to about 2.7% TiO₂ by weight of the aluminosilicate.

20. The aluminosilicate according to any one of paragraphs 14 to 19, wherein the aluminosilicate has a d₅₀ of about 190 μm or less, for example about 180 μm or less, for example about 170 μm or less.

21. The aluminosilicate according to any one of paragraphs 14 to 20, wherein the aluminosilicate is derived from a first aluminosilicate (e.g. kaolin) comprising at least about 1% Fe₂O₃ and greater than about 1.5% TiO₂ by weight of the first aluminosilicate (e.g. kaolin).

22. The aluminosilicate according to any one of paragraphs 14 to 21, wherein the aluminosilicate is derived from a first aluminosilicate (e.g. kaolin) comprising equal to or greater than about 90% kaolinite by weight of the first aluminosilicate (e.g. kaolin), for example equal to or greater than about 95% kaolinite by weight of the first aluminosilicate (e.g. kaolin).

23. The aluminosilicate according to any one of paragraphs 14 to 22, wherein the aluminosilicate has a water demand in cement equal to or less than about 1000 g/kg, for example equal to or less than about 950 g/kg, for example equal to or less than about 900 g/kg.

24. The aluminosilicate according to any one of paragraphs 14 to 23, wherein the aluminosilicate is derived from kaolin.

25. The aluminosilicate according to any one of paragraphs 14 to 24, wherein the aluminosilicate is metakaolin.

26. A composition comprising the aluminosilicate according to any one of paragraphs 1 to 25.

27. A binder composition comprising the aluminosilicate according to any one of paragraphs 1 to 25.

28. The binder composition according to paragraph 27, further comprising Portland cement.

29. A cementitious composition comprising a binder composition according to paragraph 27 or 28.

30. The cementitious composition according to paragraph 29, wherein the cementitious composition is concrete, mortar or grout.

31. A clinker composition comprising an aluminosilicate according to any one of paragraphs 1 to 25.

32. Use of an aluminosilicate according to any one of paragraphs 1 to 25 in a binder composition and/or a cementitious composition and/or a clinker composition.

33. A method of making an aluminosilicate comprising calcining a first aluminosilicate (e.g. kaolin) to form an aluminosilicate according to any one of paragraphs 1 to 25.

34. The method according to paragraph 33, wherein the first aluminosilicate (e.g. kaolin) comprises at least about 1% Fe₂O₃ and greater than about 1.5% TiO₂ by weight of the first aluminosilicate (e.g. kaolin).

35. The method according to paragraph 33 or 34, wherein the first aluminosilicate (e.g. kaolin) comprises at least about 90% kaolinite, for example at least about 95% kaolinite by weight of the first aluminosilicate (e.g. kaolin).

36. The method according to any one of paragraphs 33 to 35, wherein the calcining is carried out by flash calcination.

37. An aluminosilicate according to any one of paragraphs 1 to 25, obtained by and/or obtainable by calcining a first aluminosilicate (e.g. kaolin).

38. The aluminosilicate according to paragraph 37, wherein the aluminosilicate is obtained by and/or obtainable by a method according to any one of paragraphs 33 to 36.

39. The aluminosilicate according to paragraph 37 or paragraph 38, wherein the first aluminosilicate(e.g. kaolin) comprises at least about 1% Fe₂O₃ and greater than about 1.5% TiO₂ by weight of the first aluminosilicate (e.g. kaolin).

40. The aluminosilicate according to any one of paragraphs 37 to 39, wherein the first aluminosilicate (e.g. kaolin) comprises at least about 90% kaolinite, for example at least about 95% kaolinite by weight of the first aluminosilicate (e.g. kaolin).

41. A clinker composition comprising a first aluminosilicate (e.g. kaolin), wherein the first aluminosilicate (e.g. kaolin) comprises at least about 1% Fe₂O₃ and greater than about 1.5% TiO₂ by weight of the first aluminosilicate (e.g. kaolin).

42. A clinker composition comprising a first aluminosilicate (e.g. kaolin), wherein the first aluminosilicate (e.g. kaolin) comprises at least about 90% kaolinite, for example at least about 95% kaolinite by weight of the first aluminosilicate (e.g. kaolin).

43. Use of a clinker composition according to paragraph 41 or 42 to make a composition comprising an aluminosilicate, for example an aluminosilicate having a pozzolanic activity greater than about 1400 mg Ca(OH)₂ per gram of aluminosilicate or an aluminosilicate having a pozzolanic activity of less than about 1400 mg Ca(OH)₂ per gram of aluminosilicate and a d₅₀ of 200 μm or less.

44. An aluminosilicate comprising:

from about 45% to about 60% SiO₂ by weight of the aluminosilicate; and/or from about 35% to about 55% Al₂O₃ by weight of the aluminosilicate; and/or from about 0.2% to about 2.0% Fe₂O₃ by weight of the aluminosilicate; and/or from about 2.0% to about 3.0% TiO₂ by weight of the aluminosilicate.

45. The aluminosilicate according to paragraph 44, wherein the aluminosilicate comprises from about 51% to about 54% SiO₂ by weight of the aluminosilicate.

46. The aluminosilicate according to paragraph 44 or paragraph 45, wherein the aluminosilicate comprises from about 43% to about 45% Al₂O₃ by weight of the aluminosilicate.

47. The aluminosilicate according to any one of paragraphs 44 to 46, wherein the aluminosilicate comprises from about 0.5% to about 1.5% Fe₂O₃ by weight of the aluminosilicate.

48. The aluminosilicate according to any one of paragraphs 44 to 47, wherein the aluminosilicate comprises from about 2.3% to about 2.7% TiO₂ by weight of the aluminosilicate.

49. The aluminosilicate according to any one of paragraphs 44 to 48, wherein the aluminosilicate has a d₅₀ of less than about 10 μm, for example less than about 9 μm, for example less than about 8 μm, for example less than about 7 μm, for example less than about 6 μm, for example less than about 5 μm, for example less than about 4 μm, for example about 3 μm.

50. The aluminosilicate according to any one of paragraphs 44 to 49, wherein the aluminosilicate is derived from a first aluminosilicate (e.g. kaolin) comprising at least about 1% Fe₂O₃ and greater than about 1.5% TiO₂ by weight of the first aluminosilicate (e.g. kaolin).

51. The aluminosilicate according to any one of paragraphs 44 to 50, wherein the aluminosilicate is derived from a first aluminosilicate (e.g. kaolin) comprising at least about 90%, for example at least about 95% kaolinite by weight of the first aluminosilicate (e.g. kaolin).

52. The aluminosilicate according to any one of paragraphs 44 to 51, wherein the aluminosilicate has a water demand in cement equal to or less than about 1000 g/kg, for example equal to or less than about 950 g/kg, for example equal to or less than about 900 g/kg.

53. The aluminosilicate according to any one of paragraphs 44 to 52, wherein the aluminosilicate is derived from kaolin.

54. The aluminosilicate according to any one of paragraphs 44 to 53, wherein the aluminosilicate is metakaolin.

55. A composition comprising the aluminosilicate according to any one of paragraphs 44 to 54.

56. A binder composition comprising the aluminosilicate according to any one of paragraphs 44 to 54.

57. The binder composition according to paragraph 56, further comprising Portland cement.

58. A cementitious composition comprising a binder composition according to paragraph 56 or 57.

59. The cementitious composition according to paragraph 58, wherein the cementitious composition is concrete, mortar or grout.

60. A clinker composition comprising an aluminosilicate according to any one of paragraphs 44 to 54.

61. A method of making an aluminosilicate comprising calcining a first aluminosilicate (e.g. kaolin) to form an aluminosilicate according to any one of paragraphs 44 to 54.

62. The method of paragraph 61, wherein the first aluminosilicate (e.g. kaolin) comprises at least about 1% Fe₂O₃ and greater than about 1.5% TiO₂ by weight of the first aluminosilicate (e.g. kaolin).

63. The method according to paragraph 61 or 62, wherein the first aluminosilicate (e.g. kaolin) comprises at least about 90%, for example at least about 95% kaolinite by weight of the first aluminosilicate (e.g. kaolin).

64. The method according to any one of paragraphs 61 to 63, wherein the calcining is carried out by flash calcination.

65. An aluminosilicate according to any one of paragraphs 44 to 54, obtained by and/or obtainable by calcining kaolin.

66. The aluminosilicate according to paragraph 65, wherein the aluminosilicate is obtained by and/or obtainable by a method according to any one of paragraphs 61 to 64.

67. The aluminosilicate according to paragraph 65 or 66, wherein the first aluminosilicate (e.g. kaolin) comprises at least about 1% Fe₂O₃ and greater than about 1.5% TiO₂ by weight of the first aluminosilicate (e.g. kaolin).

68. The aluminosilicate according to any one of paragraphs 65 to 67, wherein the first aluminosilicate (e.g. kaolin) comprises at least about 90%, for example at least about 95% kaolinite by weight of first aluminosilicate (e.g. kaolin).

1. An aluminosilicate having a pozzolanic activity of greater than about 1400 mg Ca(OH)₂ per gram of aluminosilicate.

2. The aluminosilicate according to claim 1, wherein the aluminosilicate has a pozzolanic activity equal to or greater than about 1450 mg Ca(OH)₂ per gram of aluminosilicate.

3. The aluminosilicate according to claim 1, wherein the aluminosilicate comprises at least one of:
from about 45% to about 60% SiO₂ by weight of the aluminosilicate,
from about 35% to about 55% Al₂O₃ by weight of the aluminosilicate,
from about 0.2% to about 2.0% Fe₂O₃ by weight of the aluminosilicate, or
from about 2.0% to about 3.0% TiO₂ by weight of the aluminosilicate.

4. The aluminosilicate according to claim 1, wherein the aluminosilicate has a d₅₀ of less than about 10 μm.

5. The aluminosilicate according to claim 1, wherein
the aluminosilicate is derived from a first aluminosilicate comprising at least about 1% Fe₂O₃ and greater than about 1.5% TiO₂ by weight of the first aluminosilicate,
the aluminosilicate. is derived from a first aluminosilicate comprising at least about 90% kaolinite by weight of the first aluminosilicate, or
the aluminosilicate is derived from kaolin.

6. The aluminosilicate according to claim 1, wherein the aluminosilicate has a water demand in cement equal to or less than about 1000 g/kg.

7. The aluminosilicate according to claim 1 wherein the aluminosilicate is metakaolin.

8. A composition comprising the aluminosilicate according to claim 1.

9. (canceled)

10. A method of making an aluminosilicate comprising calcining a first aluminosilicate to form the aluminosilicate according to claim 1.

11. The method according to claim 10,
wherein the first aluminosilicate comprises at least about 1% Fe₂O₃ and greater than about 1.5% TiO₂ by weight of the first aluminosilicate, or
wherein the first aluminosilicate comprises at least about 90% kaolinite by weight of the first aluminosilicate.

12. The method according to claim 10, wherein the calcining is carried out by flash calcination.

13. An aluminosilicate according to claim 1, obtained by calcining a first aluminosilicate.

14. A clinker composition comprising a first aluminosilicate, wherein the first aluminosilicate comprises at least about 1% Fe₂O₃ and greater than about 1.5% TiO₂ by weight of the first aluminosilicate.

15. The clinker composition according to claim 14, wherein the first aluminosilicate comprises at least about 90% kaolinite by weight of the first aluminosilicate.

16. A method of preparing a composition, the method comprising using the clinker composition according to claim 14, to make a composition comprising a metakaolin having a pozzolanic activity of greater than about 1400 mg Ca(OH)₂ per gram of metakaolin.

17. (canceled)

18. The composition of claim 8, wherein the composition is a binder composition, a cement, a concrete, a mortar, a grout, a 3D printing material, a geopolymer, or a clinker composition.

19. The clinker composition of claim 14, wherein the first aluminosilicate comprises kaolin.

20. The aluminosilicate of claim 1, wherein the aluminosilicate is derived from kaolin.
